(19) United States
(12) Patent Application Publication
(10) Pub. No.: US 2025/0384294 A1
(43) Pub. Date: Dec. 18, 2025

(54) EVALUATION SYSTEM, INFORMATION PROCESSING SYSTEM, EVALUATION METHOD, AND RECORDING MEDIUM

(71) Applicant: NEC Corporation, Minato-ku, Tokyo (JP)

(72) Inventors: Toshio KOIDE, Tokyo (JP); Ryo FURUKAWA, Tokyo (JP)

(73) Assignee: NEC Corporation, Minato-ku, Tokyo (JP)

(21) Appl. No.: 18/879,029

(22) PCT Filed: Sep. 29, 2022
(86) PCT No.: PCT/JP2022/036502

§ 371 Date: Dec. 26, 2024

(51) Int. Cl. G06N 3/098; G06F 21/14

(52) U.S. Cl. CPC G06N 3/098; G06F 21/14

(57) ABSTRACT

An evaluation system according to the present invention includes: a memory configured to store instructions; and one or more processors. The one or more processors is configured to execute the instructions to: acquire, for a plurality of local models of learning participants for inferring a specific event, parameters of the plurality of local models; integrate the acquired parameters of the plurality of local models; execute the inference using an integrated model obtained by integrating the parameters of the plurality of local models; evaluate a contribution of each of the local models based on a result of the inference; and output the contribution.

### TECHNICAL FIELD

The present disclosure relates to an evaluation system, an information processing system, an evaluation method, and a recording medium.

### BACKGROUND ART

Regarding an artificial intelligence (AI) model for solving problems with an organization, there is an approach of sharing an AI model in each organization by linking only parameters of the AI model without outputting data possessed by each organization to the outside.

For example, PTL 1 discloses updating a learned model held by each learning device by applying a result of integrating learned models collected from a plurality of learning devices to respective learning devices.

### CITATION LIST

Patent Literature

PTL 1: JP 2020-115311 A

### SUMMARY OF INVENTION

### Technical Problem

Thus, when learned models learned by respective learning devices are integrated as in the invention described in PTL 1, there is a difference in the contribution to the updated integrated model. However, there is no method of appropriately evaluating a learning participant having a high contribution. For this reason, for example, the reward to the learning participant cannot be appropriately calculated, and each organization does not want to participate in the federated learning.

An object of the present disclosure is to provide an evaluation system capable of appropriately evaluating a learning participant.

### Solution to Problem

An evaluation system according to an aspect of the present disclosure includes a parameter acquisition means for acquiring, for a plurality of local models of learning participants for inferring a specific event, parameters of the plurality of local models, an integration means for integrating the acquired parameters of the plurality of local models, an inference means for executing the inference using an integrated model obtained by integrating the parameters of the plurality of local models, an evaluation means for evaluating a contribution of each of the local models based on a result of the inference, and an output means for outputting the contribution.

An evaluation system according to an aspect of the present disclosure includes an inference means for executing inference regarding a specific event based on an integrated model in which parameters of a plurality of local models are integrated by federated learning using secure computation, an evaluation means for evaluating a contribution of each of the local models based on a result of the inference, and an output means for outputting the contribution.

An information processing system according to an aspect of the present disclosure includes a plurality of learning participant servers and the evaluation system described above, wherein each of the learning participant servers includes a model storage means for storing a learned model for executing inference regarding a specific event, an input/output means for inputting, in an obfuscated format, a parameter updated by federated learning using secure computation for parameters of the stored model, a restoration unit that restores the input parameter, and a participant inference means for applying the restored parameter to the stored model to update the model, and executing inference regarding the specific event.

An evaluation method according to an aspect of the present disclosure executed by a computer includes acquiring, for a plurality of local models of learning participants for inferring a specific event, parameters of the plurality of local models, integrating the acquired parameters of the plurality of local models, executing the inference using an integrated model obtained by integrating the parameters of the plurality of local models, evaluating a contribution of each of the local models based on a result of the inference, and outputting the contribution.

A recording medium according to an aspect of the present disclosure stores a program for causing a computer to execute the steps of acquiring, for a plurality of local models of learning participants for inferring a specific event, parameters of the plurality of local models, integrating the acquired parameters of the plurality of local models, executing the inference using an integrated model obtained by integrating the parameters of the plurality of local models, evaluating a contribution of each of the local models based on a result of the inference, and outputting the contribution.

### Advantageous Effects of Invention

An example of the effect of the present disclosure can provide an evaluation system capable of appropriately evaluating a learning participant.

### BRIEF DESCRIPTION OF DRAWINGS

FIG. 1 is a block diagram illustrating a configuration of an information processing system according to the first example embodiment.

FIG. 2 is a diagram illustrating a hardware configuration in which the evaluation system according to the first example embodiment is implemented by a computer device and its peripheral device.

FIG. 3 is a diagram for describing a threshold value of inference accuracy in the first example embodiment.

FIG. 4 is a flowchart illustrating an operation of calculation in the first example embodiment.

FIG. 5 is a block diagram illustrating a configuration of an information processing system according to a modification of the first example embodiment.

FIG. 6 is a diagram illustrating a presentation example of a type of insufficient data presented by a presentation unit in the first example embodiment.

FIG. 7 is a flowchart illustrating an operation of information processing in a modification of the first example embodiment.

FIG. 8 is a block diagram illustrating a configuration example of an information processing system according to the second example embodiment.

FIG. 9 is a flowchart illustrating an operation of information processing in the second example embodiment.

### EXAMPLE EMBODIMENT

An example embodiment will be described in detail with reference to the drawings.

### First Example Embodiment

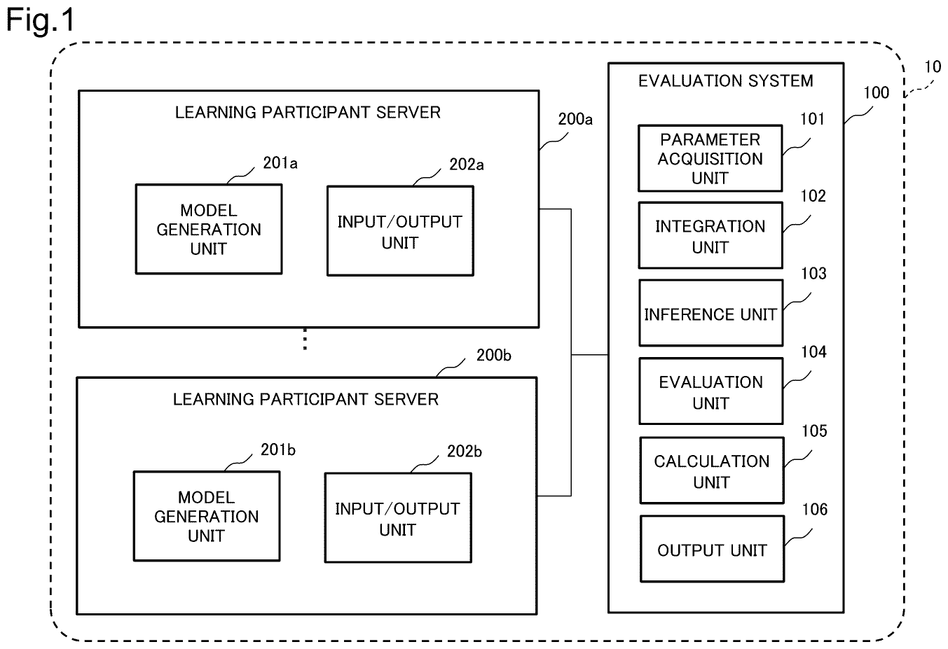

FIG. 1 is a block diagram illustrating a configuration of an information processing system 10 according to the first example embodiment. An information processing system 10 in the first example embodiment is a system for calculating a reward of each learning participant in a case where an integrated model in which a plurality of local models for inferring a specific event, the local models being possessed by respective learning participant, is integrated by federated learning is generated. The federated learning may be performed a plurality of times to generate an integrated model that satisfies a predetermined condition. Examples of the learning participant include an organization such as a local government or a company.

Referring to FIG. 1, the information processing system 10 includes an evaluation system 100 and a plurality of learning participant servers 200 (200a, 200b). The evaluation system 100 outputs the inference result related to the event by inputting the explanatory variable value to the integrated model. The specific event is, for example, a matter that can be expressed by an any form of model (mathematical expression) using an explanatory variable related to a factor that affects the event. The model of the present example embodiment is a model obtained by learning a factor and an occurrence condition of an event from past case data, and receives an explanatory variable value to output an inference result of an improvement condition for solving the factor of the event. Examples of the inference target include, for example, measures for encouraging employees to change their behavior in order to improve the health and productivity of employees, measures for encouraging citizens to change their behavior in order to reduce medical costs of health insurance in local governments, and measures for promoting utilization of public facilities such as libraries and gymnasiums. However, the events inferred by the evaluation system 100 are not limited thereto.

The evaluation system 100 includes a parameter acquisition unit 101, an integration unit 102, an inference unit 103, an evaluation unit 104, a calculation unit 105, and an output unit 106. However, the calculation unit 105 is an any configuration requirement. Each of the learning participant servers 200 includes a model generation unit 201 (201a, 201b) that generates a model for inferring a specific event, and an input/output unit 202 (202a, 202b) that receives and outputs parameters from and to the evaluation system 100. In the present example embodiment, the number of the plurality of learning participant servers 200 is two, but the present invention is not limited thereto. The number of the plurality of learning participant servers 200 is the number of learning participants participating in learning. Hereinafter, the evaluation system 100 that is an essential configuration of the present example embodiment will be described in detail.

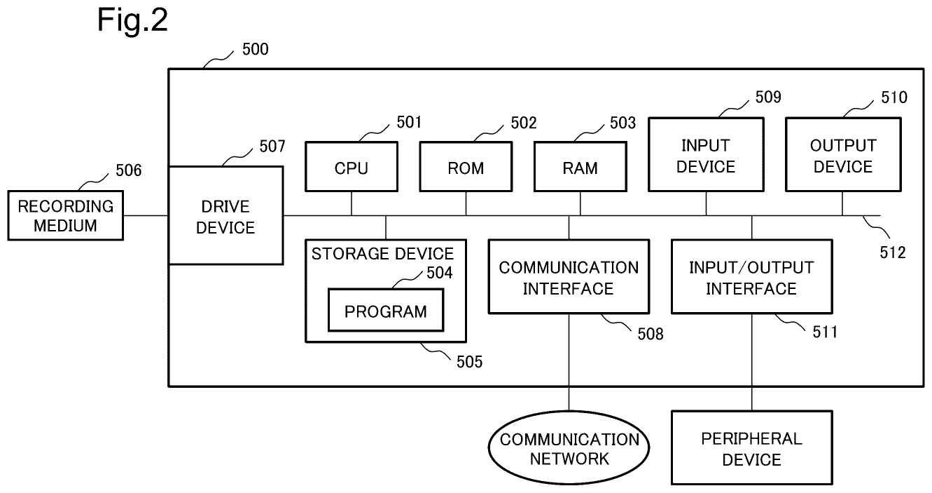

FIG. 2 is a diagram illustrating an example of a hardware configuration in which the evaluation system 100 according to the first example embodiment of the present disclosure is implemented by a computer device 500 including a processor. As illustrated in FIG. 2, the evaluation system 100 includes a central processing unit (CPU) 501, a memory such as a read only memory (ROM) 502 and a random access memory (RAM) 503, a storage device 505 such as a hard disk that stores a program 504, a communication interface (I/F) 508 for network connection, and an input/output interface 511 that inputs and outputs data. In the first example embodiment, the parameter information received from each learning participant server 200 is input to the evaluation system 100 via the communication I/F 508.

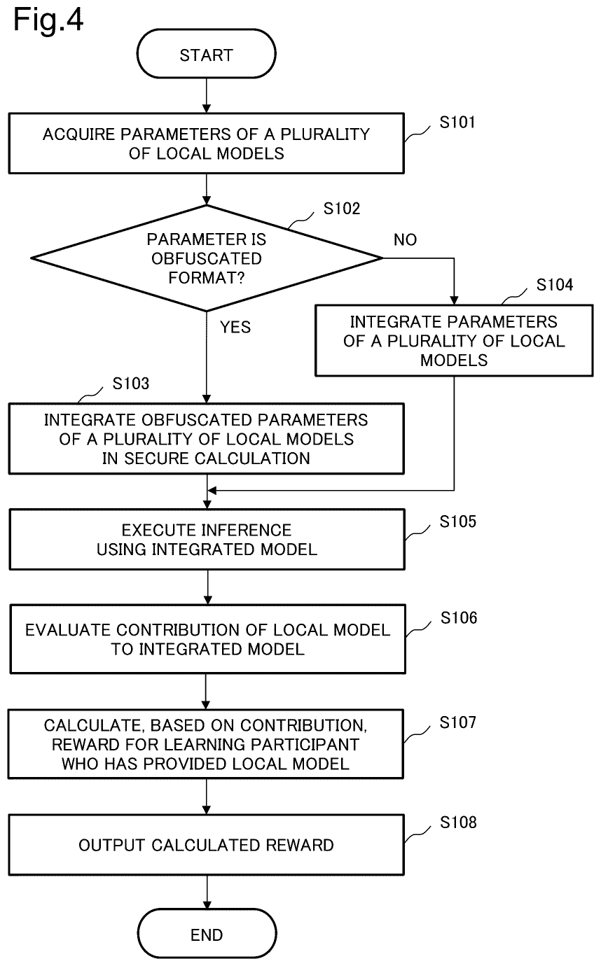

The CPU 501 operates an operating system to control the entire evaluation system 100 according to the first example embodiment of the present invention. The CPU 501 reads a program and data from a recording medium 506 attached to a drive device 507 or the like to a memory, for example. The CPU 501 functions as the parameter acquisition unit 101, the integration unit 102, the inference unit 103, the evaluation unit 104, the calculation unit 105, the output unit 106, and part thereof in the first embodiment, and executes processing or a command in the flowchart illustrated in FIG. 4 described later based on a program.

The recording medium 506 is, for example, an optical disk, a flexible disk, a magnetic optical disk, an external hard disk, a semiconductor memory, or the like. A recording medium as part of the storage device is a nonvolatile storage device, and records a program therein. The program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to check an output.

As described above, the first example embodiment illustrated in FIG. 1 is implemented by the computer hardware illustrated in FIG. 2. However, the means for achieving each unit included in the evaluation system 100 in FIG. 1 is not limited to the above-described configuration. The evaluation system 100 may be achieved by one physically coupled device, or may be achieved by a plurality of devices by connecting two or more physically separated devices in a wired or wireless manner. For example, the input device 509 and the output device 510 may be connected to the computer device 500 via a network. The evaluation system 100 according to the first example embodiment illustrated in FIG. 1 can also be configured by cloud computing or the like.

For example, the parameter acquisition unit 101 acquires the parameters of the learned model in each of the plurality of learning participant servers 200 using an operation for performing the federated learning as a trigger. The model is, for example, a model learned by machine learning in order to output an inference result regarding a specific event in each learning participant. The model for machine learning includes, but is not limited to, a decision tree model, a linear regression model, a logistic regression model, a neural network model, and the like.

The integration unit 102 integrates the parameters of respective models of the plurality of models. As a parameter integration method, a known method can be used, and for example, at the time of integration, the weight of the parameter related to each model can be changed according to the feature of each model. For example, the integration unit 102 applies the parameters obtained in this manner to the model and stores the parameters in the storage device 505.

The parameter acquisition unit 101 may acquire the parameter from each learning participant server 200 in an obfuscated format. In this case, the integration unit 102 integrates the parameters of the plurality of obfuscated local models in secure computation. In the present example embodiment, integrating parameters of a plurality of obfuscated local models in secure computation means that the evaluation system 100 performs machine learning with the machine learning being distributed to each learning participant server 200 (federated learning), and integrates parameters of learned models using secure computation to generate a new integrated model. The parameter acquired by the parameter acquisition unit 101 from each learning participant servers 200 is obtained by obfuscating a difference from the parameter before the federated learning. In the present example embodiment, in a case where the federated learning is repeatedly performed, the parameter acquired by the parameter acquisition unit 101 is obtained by obfuscating a difference from the parameter before the preceding federated learning.

In the present example embodiment, obfuscation is synonymous with encryption. The secure computation is to perform calculation while keeping data obfuscated, and the evaluation system 100 side that acquires and integrates parameters of the local model cannot refer to the obfuscated raw data. As a method of secure computation, special encryption related to specific processing such as homomorphic encryption, a trusted execution environment in which processing is performed in an isolated state on hardware, multi-party calculation in which calculation processing (secret distribution calculation) is performed in a state of being secret distributed in a plurality of servers, or the like can be used.

A specific method of the secure computation of the multi-party calculation includes the following examples. For example, the obfuscated data a, which is a parameter acquired from an any learning participant server, is distributed in secret to the variance values x1, y1 . . . , and the variance values x1, y1, . . . are transmitted to servers whose administrators are different. The obfuscated data b, which is a parameter acquired from another learning participant server, is distributed in secret to the variance values x2, y2, . . . , and the variance values x2, y2, . . . are transmitted to servers whose administrators are different. Next, the calculation is advanced while communicating with each other in a state where the obfuscated data a and the obfuscated data b are dispersed in secret and, finally, the variance values u, v . . . of the outputs, which are the calculation results of the respective servers, are collected and the restoration processing is performed, so that F(a, b) of the calculation result is obtained. This calculation result is a parameter obtained by integrating parameters of respective models. Therefore, in a case where the multi-party calculation is used as the secure computation method, the integration unit 102 includes a plurality of servers. According to the multi-party calculation, management of an encryption key and an isolated environment are unnecessary, and calculation processing is faster. The integration unit 102 restores the parameter of the model obtained in this manner, and stores the model to which the restored parameter is applied in the storage device 505.

The inference unit 103 is a means for executing inference based on an integrated model obtained by integrating parameters of a plurality of local models. The inference unit 103 executes inference by inputting an explanatory variable value to the integrated model stored in the storage device 505. In a case where the parameter of the integrated model is obfuscated, the inference unit 103 may execute inference by secure computation, or may execute inference after decoding the parameter of the integrated model. The inference unit 103 outputs the inferred inference result to the evaluation unit 104.

The evaluation unit 104 is a means for evaluating the contribution of the local model based on the inferred inference result. In the present example embodiment, the evaluation unit 104 evaluates the contribution of each local model based on, for example, improvement in inference accuracy of the integrated model by integration of the local models. The evaluation unit 104 determines the contribution of each local model based on a difference between the inference accuracy of the integrated model when the parameter of the local model is integrated and the inference accuracy when the parameter of the local model is not integrated. In the present example embodiment, the inference accuracy refers to the accuracy rate of the improvement condition for the factor of the event output by the model. In other words, the inference accuracy indicates how much the event has been improved as a result of taking measures to satisfy the improvement condition output by the model.

A method of evaluating the contribution of the local model of each organization when the integrated model is generated by integrating the local models of the learning participants A to C will be specifically described. For example, in a case of calculating the contribution of the local model of the learning participant A, the evaluation unit 104 calculates the inference accuracy of the integrated model in a case where the local models of the learning participant B and the learning participant C are integrated. The evaluation unit 104 compares the inference accuracy of the integrated model when the local models of the learning participant B and the learning participant C are integrated with the inference accuracy of the integrated model when the parameters of all the local models of the learning participants A to C are integrated, and evaluates the contribution based on the improvement rate of the inference accuracy.

Similarly, when evaluating the contribution of the local model of the learning participant B, the evaluation unit 104 evaluates the inference accuracy of the integrated model in a case where the parameters of the local models of the learning participant A and the learning participant C are integrated. Next, the evaluation unit 104 compares the inference accuracy of the integrated model when the local models of the learning participant B and the learning participant C are integrated with the inference accuracy of the integrated model when the parameters of all the local models of the learning participants A to C are integrated, and evaluates the contribution based on the improvement rate of the inference accuracy. The evaluation unit 104 similarly evaluates the contribution of the learning participant C. However, the method of evaluating the contribution of each local model is not limited thereto.

In a case where the learning participant participates in the federated learning before the inference accuracy of the integrated model reaches a predetermined threshold value, the evaluation unit 104 may add the contribution of the local model. That is, in a case where the parameter acquisition unit 101 acquires the parameter of the local model before the inference accuracy of the integrated model reaches the predetermined threshold value, the evaluation unit 104 may add the contribution of the local model. In a case where the inference accuracy of the integrated model decreases after performing the federated learning, the evaluation unit 104 may evaluate the contribution as negative, and may not integrate the parameter of the local model of the learning participant participating in the federated learning at the time.

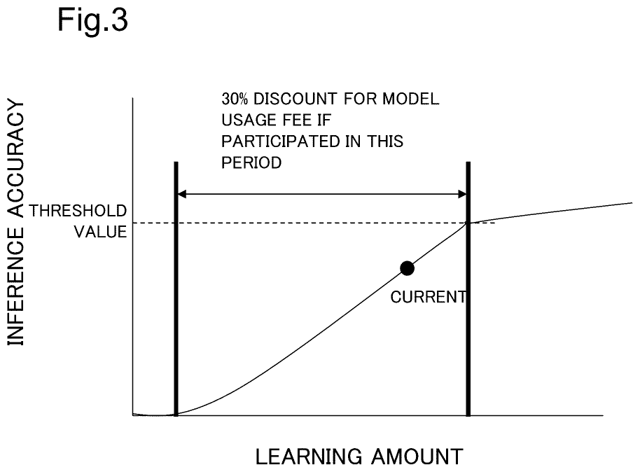

FIG. 3 is a diagram for describing a threshold value of the inference accuracy of the integrated model. As illustrated in FIG. 3, the inference accuracy gradually increases according to the learning amount of the model, and when the inference accuracy reaches a predetermined threshold value, the increase in the inference accuracy is gentle. The evaluation unit 104 may add the contribution for the learning participant participating in the federated learning in a duration before reaching a threshold value, during which the degree of increase in inference accuracy is large. In the example of FIG. 3, it is described that the contribution is added (discount of the model usage fee) for the learning participant participating in the federated learning before reaching the threshold value. The evaluation unit 104 may set a threshold value after the federated learning, such as setting 50% of the inference accuracy of the final integrated model as a threshold value based on the final inference accuracy when the federated learning has been sufficiently completed.

The calculation unit 105 is a means for calculating a reward to the learning participant who has provided the parameter of the local model based on the contribution of the local model. In the example of the above-mentioned integrated model obtained by integrating the parameters of the local models of the learning participants A to C, the calculation unit 105 sets the ratio of the calculated contribution as the ratio of the reward to be allocated to each of the business operators A to C. As a method of returning a reward to each business operator, a usage fee of the integrated model may be discounted. The calculation unit 105 may set the usage fee of the integrated model at the inference stage to be free for the learning participant of the local model who has provided the predetermined contribution or more.

In the present example embodiment, the evaluation unit 104 may evaluate the contribution of the local model based on the time at which the learning participant participated instead of the inference accuracy. That is, the evaluation unit 104 may evaluate the contribution of the local model based on the time at which the parameter acquisition unit 101 acquired the parameter of the local model. The evaluation unit 104 may evaluate the contribution based on the order of the parameters acquired from the learning participant or earliness of acquisition.

The output unit 106 is a means for outputting the evaluated contribution. For example, the output unit 106 may output the contribution of each local model to the output device 510 such as a display, or may transmit information about the contribution to each learning participant. The output unit 106 may output information about reward.

The operation of the evaluation system 100 configured as described above will be described with reference to the flowchart of FIG. 4.

FIG. 4 is a flowchart illustrating an outline of the operation of the evaluation system 100 in the first example embodiment. The processing according to this flowchart may be executed based on program control by the processor described above. A series of processes according to this flowchart may not be performed continuously, and for example, steps S101 to S104 and steps S105 to S108 in FIG. 4 may be performed at different timings. The processing of calculating the reward for the learning participant in step S107 may be skipped. In this case, in step S108, the output unit 106 outputs the contribution.

As illustrated in FIG. 4, first, the parameter acquisition unit 101 acquires a parameter of a learned local model for inferring a specific event from each learning participant server 200 (step S101). In a case where the evaluation system 100 performs calculation in an obfuscated manner, that is, in a case where the parameters of the plurality of local models acquired by the parameter acquisition unit 101 are in an obfuscated format (step S102: YES), the integration unit 102 integrates the obfuscated parameters of the plurality of local models in secure computation (step S103). On the other hand, in a case where the evaluation system 100 performs calculation without obfuscation, that is, in a case where the parameters of the plurality of local models acquired by the parameter acquisition unit 101 are not in an obfuscated format (step S102: NO), the integration unit 102 integrates the parameters of the plurality of local models without using secure computation (step S104).

The inference unit 103 executes inference using the integrated model (step S105), and then the evaluation unit 104 evaluates a contribution of the local model to the integrated model (step S106). The calculation unit 105 calculates the reward for the learning participant based on the contribution (step S107). The output unit 106 outputs the calculated reward (step S108). Thus, the evaluation system 100 ends the calculation operation.

In the present example embodiment, in the evaluation system 100, the evaluation unit 104 evaluates a contribution of the local model to the integrated model. Therefore, it is possible to appropriately evaluate the learning participant. The calculation unit 105 calculates the reward for the learning participant based on the contribution. Therefore, the reward for the learning participant can be appropriately set based on the contribution of the local model to the integrated model. In the evaluation system 100, the evaluation unit 104 adds the contribution of the local model in a case where the learning participant participates in the federated learning before the inference accuracy of the integrated model reaches a predetermined threshold value. As a result, since the contribution of the learning participant who has participated in the federated learning at an early stage can be appropriately evaluated, it is possible to encourage each organization to participate even at an initial stage of the federated learning.

In the evaluation system 100, in a case where the parameters of the plurality of local models acquired by the parameter acquisition unit 101 are in the obfuscated format, the integration unit 102 integrates the obfuscated parameters of the plurality of local models in secure computation. As a result, the integrated model can be used while concealing the parameters of respective models.

### Modification of First Example Embodiment

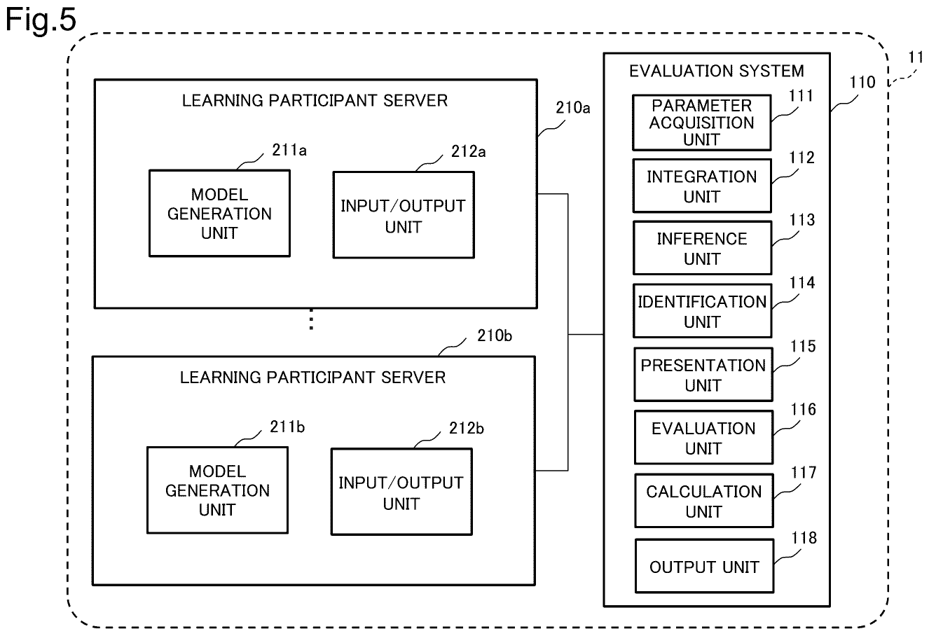

Next, a modification of the first example embodiment of the present disclosure will be described in detail with reference to the drawings. Hereinafter, description of content overlapping with the above description will be omitted to the extent that the description of the present example embodiment is not unclear. FIG. 5 is a block diagram illustrating a configuration of an information processing system according to the modification of the first example embodiment. As illustrated in FIG. 5, an evaluation system 110 in an information processing system 11 includes a parameter acquisition unit 111, an integration unit 112, an inference unit 113, an identification unit 114, a presentation unit 115, an evaluation unit 116, a calculation unit 117, and an output unit 118. That is, the evaluation system 110 is at least different from the evaluation system 100 according to the first example embodiment in that it includes the identification unit 114 and the presentation unit 115.

In the present example embodiment, the inference unit 113 inputs the explanatory variable value for each type and infers the event using the integrated model. The type of learning data is a type classified according to attributes such as age and gender, or personal data such as behavior history and family structure. The inference unit 113 calculates the inference accuracy of each type for the integrated model to output it to the identification unit 114.

The identification unit 114 is a means for identifying the type of the insufficient learning data based on at least any one of the type, event, and inference accuracy of the learning data learned by the integrated model. The identification unit 114 identifies a type having inference accuracy equal to or less than a predetermined value based on the inference accuracy for each type input from the inference unit 113. The identification unit 114 may identify a type having less learning data for the integrated model. In this case, when the learning amount of the past failure case data is equal to or less than a predetermined amount, the identification unit 114 may identify the failure case data as insufficient learning data.

The presentation unit 115 is a means for presenting information for recruiting a learning participant. The presentation unit 115 presents information of a reward in a case of participating in the federated learning or information such as a current situation of the integrated model as information for recruiting a learning participant. The presentation unit 115 may present these pieces of information in a web (World Wide Web) page for inviting participation in the federated learning, or may transmit the information to an organization that is desired to participate in the federated learning. As illustrated in FIG. 3, the presentation unit 115 may present information about the reward while presenting the current inference accuracy of the integrated model and the threshold value of the inference accuracy.

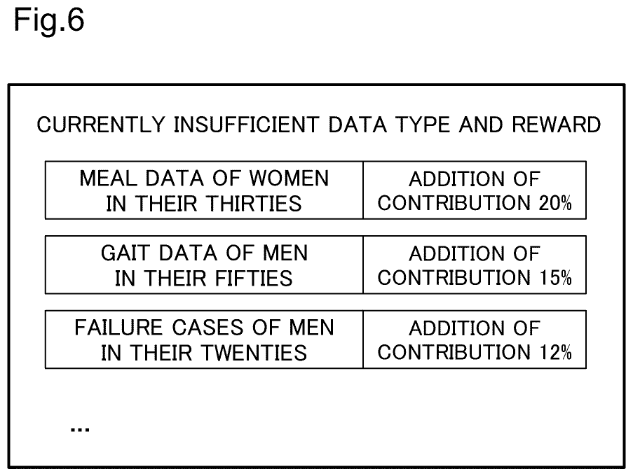

The presentation unit 115 may present the type of the learning data identified by the identification unit 114. FIG. 6 is a diagram illustrating a presentation example of the type of the insufficient data presented by the presentation unit 115. The example of FIG. 6 describes that the insufficient data and the information that the contribution will be added in a case where the parameter of the local model learned with each insufficient data is provided.

In addition to the method of evaluating the contribution by the evaluation unit 104 in the first example embodiment, the evaluation unit 116 adds the contribution in a case where the learning participant provides the parameter of the local model learned with the insufficient data. The operations of the calculation unit 117 and the output unit 118 in the present example embodiment are similar to the operations of the calculation unit 105 and the output unit 106 in the first example embodiment, and thus, description thereof is omitted here.

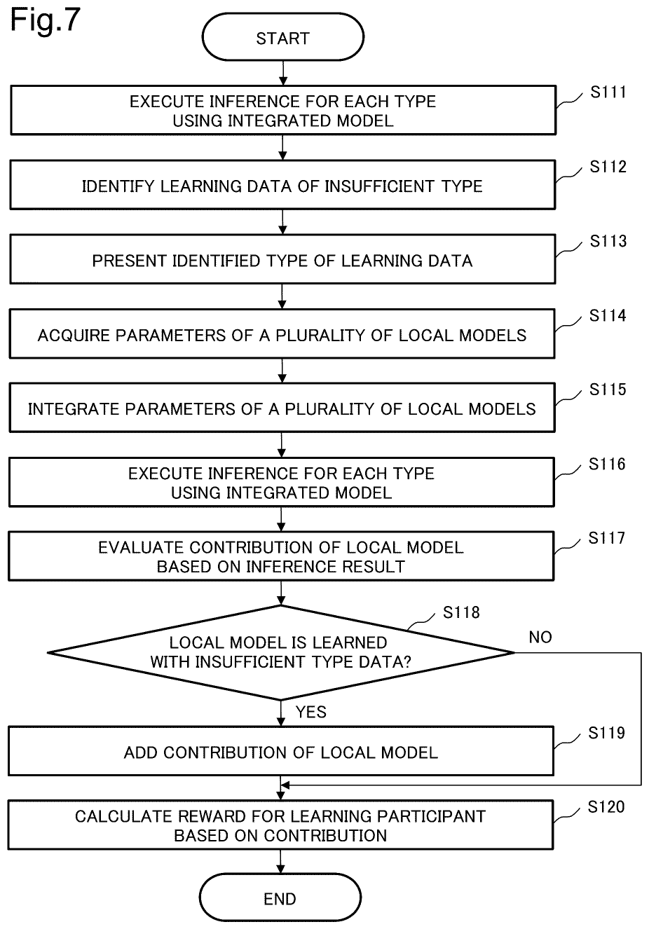

FIG. 7 is a flowchart illustrating an outline of an operation of the evaluation system 110 in the modification of the first example embodiment. The processing according to this flowchart is based on the premise that learning data of an insufficient type is presented before parameter integration (steps S114 to S115). The processing according to this flowchart may be executed based on the program control by the processor described above, as in the first example embodiment.

As illustrated in FIG. 7, first, the inference unit 113 executes inference for each type using the integrated model (step S111). Next, the identification unit 114 identifies learning data of an insufficient type (step S112). The presentation unit 115 presents the type, of the learning data, identified by the identification unit 114 (step S113).

Next, the parameter acquisition unit 111 acquires a parameter of the learned local model for inferring a specific event from each learning participant server 210 (step S114). Next, the integration unit 112 integrates the parameters of the plurality of local models (step S115).

The inference unit 113 executes inference using the integrated model (step S116), and then the evaluation unit 116 evaluates the contribution of the local model (step S117). In a case where a learning participant provides the parameter of the local model learned with the insufficient data (S118: YES), the evaluation unit 116 adds the contribution of the learning participant (step S119). Next, the calculation unit 117 calculates the reward for the learning participant based on the contribution (step S120). On the other hand, in a case where the learning participant does not provide the parameter of the local model learned with the insufficient data (S118: NO), the evaluation unit 116 does not add the contribution, and the calculation unit 117 calculates the reward for the learning participant based on the contribution (step S120). Thus, the evaluation system 110 ends the calculation operation.

In the evaluation system 110, the presentation unit 115 presents the type of the learning data identified by the identification unit 114, and in a case where a learning participant provides the parameter of the local model learned with the insufficient data, the evaluation unit 116 adds the contribution of the learning participant. As a result, it is possible to appropriately evaluate the contribution related to the contribution for the learning participant having a higher contribution to the integrated model.

### Second Example Embodiment

Next, the second example embodiment of the present disclosure will be described in detail with reference to the drawings. Hereinafter, description of content overlapping with the above description will be omitted to the extent that the description of the present example embodiment is not unclear. An information processing system 12 in the second example embodiment is used to provide each learning participant server with a model updated by federated learning using secure computation. The update model is used, for example, for each learning participant to infer a specific event. As in the computer device illustrated in FIG. 2, each component in each example embodiment of the present disclosure can be achieved not only by hardware but also by a computer device based on program control.

### <Evaluation System>

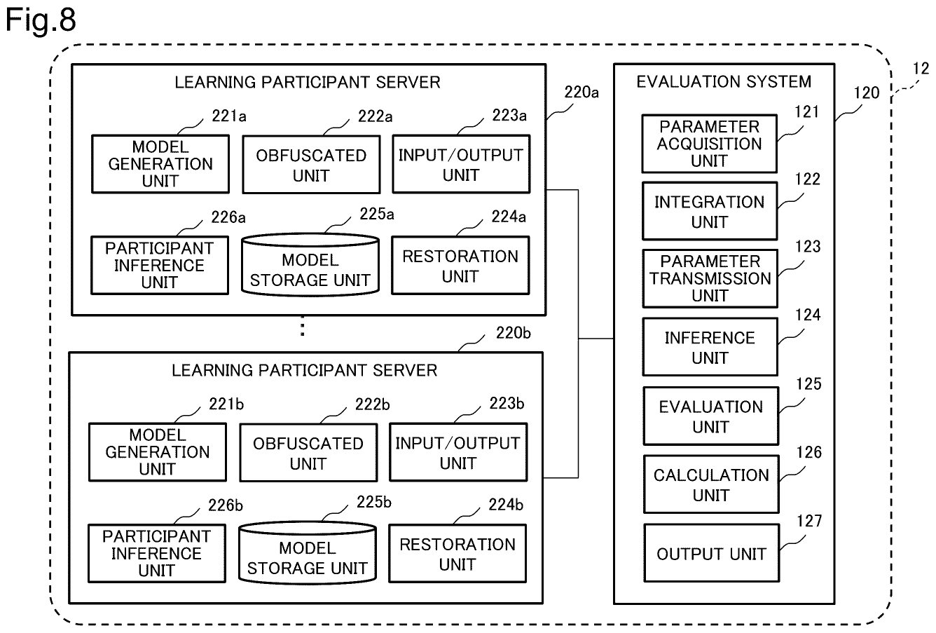

FIG. 8 is a block diagram illustrating a configuration of the information processing system 12 including an evaluation system 120 according to the second example embodiment of the present disclosure. With reference to FIG. 8, the evaluation system 120 and a learning participant server 220 (220a, 220b) according to the second example embodiment will be described focusing on the configuration different from that of the information processing system 10 according to the first example embodiment. The evaluation system 120 includes a parameter acquisition unit 121, an integration unit 122, a parameter transmission unit 123, an inference unit 124, an evaluation unit 125, a calculation unit 126, and an output unit 127.

The parameter acquisition unit 121 acquires the parameter of the learned model of each learning participant from the learning participant server 220 through the communication I/F 508. Next, the integration unit 122 integrates the received obfuscated parameters of the model in secure computation to output the integrated obfuscated parameter of the model to the parameter transmission unit 123 in an obfuscated format. The parameter transmission unit 123 transmits the integrated parameters to each learning participant server 220 through the input/output unit 223. In a case where the parameter is updated by the learning participant server 220 learning the model again after transmitting the parameter to the learning participant server 220, the evaluation system 120 may acquire the updated parameter again. The operations in the inference unit 124, the evaluation unit 125, the calculation unit 126, and the output unit 127 are similar to the operations of the related components in the first example embodiment, and thus, description thereof is omitted here.

### <Learning Participant Server>

In the second example embodiment, each of the plurality of learning participant servers 220 (220a, 220b) includes a model generation unit 221 (221a, 221b), an obfuscated unit 222 (222a, 222b), an input/output unit 223 (223a, 223b), a restoration unit 224 (224a, 224b), a model storage unit 225 (225a, 225b), and a participant inference unit 226 (226a, 226b). The model storage unit 225 stores the model generated by the model generation unit 221.

The learning participant server 220 updates the model stored in the model storage unit 225 to a model to which the parameter received from the evaluation system 120 is applied. Specifically, the input/output unit 223 receives the parameter in the obfuscated format to output the parameter to the restoration unit 224. Next, the restoration unit 224 restores the parameter and replaces the parameter with the parameter of the model stored in the model storage unit 225. Next, the participant inference unit 226 performs inference using the updated model. In order to enhance the accuracy of the result of the inference by the participant inference unit 226, the learning participant server 220 may perform learning again based on the additionally obtained learning data and further transmit the further updated parameter to the evaluation system 120. The accuracy of the integrated model can be further enhanced by repeating update of the parameter by learning by each learning participant server 220 and integration of the parameters by the evaluation system 120 until, for example, a predetermined condition is satisfied. The predetermined condition is stored in the storage device 505, for example.

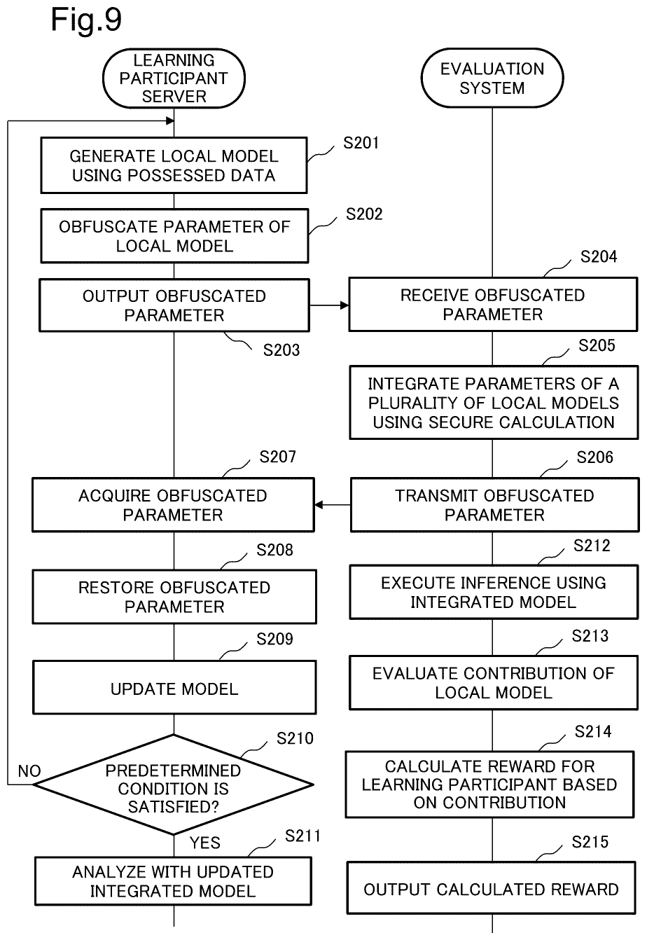

The operation of the information processing system 12 configured as described above will be described with reference to the flowchart of FIG. 9.

FIG. 9 is a flowchart illustrating an outline of an operation of the information processing system 12 according to the second example embodiment. The processing according to this flowchart may be executed based on program control by the processor described above. The calculation of the reward in steps S212 to S215 by the evaluation system 120 may be executed each time the processing of the federated learning in steps S201 to S210 is executed, or may be executed when the integrated model satisfies a predetermined condition.

As illustrated in FIG. 9, first, in the learning participant server 220, the model generation unit 221 locally generates a model using data possessed by the learning participant (step S201). Next, the obfuscated unit 222 obfuscates the parameter of the model (step S202), and the input/output unit 223 outputs the obfuscated parameter to the evaluation system 120 (step S203). Next, the parameter acquisition unit 121 of the evaluation system 120 acquires obfuscated parameter (step S204). Next, the integration unit 122 integrates the obfuscated parameters of the plurality of local models using secure computation (step S205). Next, the parameter transmission unit 123 outputs the parameter of the model integrated by the integration unit 122 to each of the learning participant servers 220 in an obfuscated format (step S206).

Next, each learning participant server 220 acquires the parameter integrated through the input/output unit 223 in an obfuscated format (step S207). Next, the restoration unit 224 restores the parameter in the obfuscated format (step S208). Next, the learning participant server 220 updates the model stored in the model storage unit 225 to the model to which the restored parameter is applied (step S209). Next, the learning participant server 220 determines whether a predetermined condition is satisfied (step S210). In a case where a predetermined condition is satisfied (step S210: YES), the participant inference unit 226 executes inference using the updated model (step S211). In a case where the predetermined condition is not satisfied, the learning participant server 220 returns the process to step S201 (step S210: NO) and perform the flow again.

On the other hand, in the evaluation system 120, the inference unit 124 executes inference using the integrated model (step S212), and then the evaluation unit 125 evaluates the contribution of the local model (step S213). The calculation unit 126 calculates the reward for the learning participant based on the contribution (step S214). The output unit 127 outputs the calculated reward (step S215). Thus, the information processing system 12 ends the operation of information processing.

In the second example embodiment of the present disclosure, the participant inference unit 226 of each learning participant server 220 executes inference regarding a specific event using a model to which parameter, of the model, integrated by the integration unit 122 is applied. As a result, a more accurate inference result can be output in each learning participant server 220.

While the present invention is described with reference to example embodiments thereof, the present invention is not limited to these example embodiments. Various modifications that can be understood by those of ordinary skill in the art can be made to the configuration and details of the present invention within the scope of the present invention.

For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments may be described as the following Supplementary Notes, but are not limited to the following.

### (Supplementary Note 1)

An evaluation system including
a parameter acquisition means for acquiring, for a plurality of local models of learning participants for inferring a specific event, parameters of the plurality of local models,
an integration means for integrating the acquired parameters of the plurality of local models,
an inference means for executing the inference using an integrated model obtained by integrating the parameters of the plurality of local models,
an evaluation means for evaluating a contribution of each of the local models based on a result of the inference, and
an output means for outputting the contribution.

### (Supplementary Note 2)

The evaluation system according to Supplementary Note 1, further including
a calculation means for calculating a reward to a learning participant who has provided a parameter of a local model based on the contribution, wherein
the output means outputs the reward.

### (Supplementary Note 3)

The evaluation system according to Supplementary Note 1 or 2, wherein
the parameter acquisition means acquires the parameters of the plurality of local models in an obfuscated format, and
the integration means integrates the parameters of the plurality of local models using secure computation.

### (Supplementary Note 4)

An evaluation system including
an inference means for executing inference regarding a specific event based on an integrated model in which parameters of a plurality of local models are integrated by federated learning using secure computation,
an evaluation means for evaluating a contribution of each of the local models based on a result of the inference, and
an output means for outputting the contribution.

### (Supplementary Note 5)

The evaluation system according to any one of Supplementary Notes 1 to 4, wherein
the evaluation means evaluates a contribution of each of the local models based on a change in inference accuracy of the integrated model due to integration of the parameters of the plurality of local models.

### (Supplementary Note 6)

The evaluation system according to any one of Supplementary Notes 1 to 4, wherein
the evaluation means evaluates a contribution of each of the local models based on a time at which a plurality of the learning participants participated in federated learning.

### (Supplementary Note 7)

The evaluation system according to Supplementary Note 5 or 6, wherein
the evaluation means adds a contribution of the local model in a case where the plurality of learning participants participates in federated learning before inference accuracy of the integrated model reaches a predetermined threshold value.

### (Supplementary Note 8)

The evaluation system according to any one of Supplementary Notes 1 to 7, further including:
a presentation means for presenting information for recruiting a learning participant.

### (Supplementary Note 9)

The evaluation system according to Supplementary Note 8, wherein
the presentation means presents current inference accuracy of the integrated model and a threshold value of inference accuracy.

### (Supplementary Note 10)

The evaluation system according to Supplementary Note 8, further including
an identification means for identifying a type of insufficient learning data based on at least any one of a type of learning data learned by the integrated model, a content of an event, and inference accuracy, wherein
the presentation means presents the identified type of the learning data.

### (Supplementary Note 11)

The evaluation system according to Supplementary Note 10, wherein
the evaluation means adds a contribution of a local model generated based on the insufficient learning data.

### (Supplementary Note 12)

An information processing system including
a plurality of learning participant servers, and
the evaluation system according to any one of Supplementary Notes 1 to 11, wherein
each of the learning participant servers includes
a model storage means for storing a learned model for executing inference regarding a specific event,
an input/output means for inputting, in an obfuscated format, a parameter updated by federated learning using secure computation for parameters of the stored model,
a restoration means for restoring the input parameter, and
a participant inference means for applying the restored parameter to the stored model to update the model, and executing inference regarding the specific event.

### (Supplementary Note 13)

An evaluation method executed by a computer, the method including
acquiring, for a plurality of local models of learning participants for inferring a specific event, parameters of the plurality of local models,
integrating the acquired parameters of the plurality of local models,
executing the inference using an integrated model obtained by integrating the parameters of the plurality of local models,
evaluating a contribution of each of the local models based on a result of the inference, and
outputting the contribution.

### (Supplementary Note 14)

A recording medium storing a program for causing a computer to execute the steps of
acquiring, for a plurality of local models of learning participants for inferring a specific event, parameters of the plurality of local models,
integrating the acquired parameters of the plurality of local models,
executing the inference using an integrated model obtained by integrating the parameters of the plurality of local models,
evaluating a contribution of each of the local models based on a result of the inference, and
outputting the contribution.

### REFERENCE SIGNS LIST

10, 11, 12 information processing system
100, 110, 120 evaluation system
101, 111, 121 parameter acquisition unit
102, 112, 122 integration unit
103, 113, 124 inference unit
104, 116, 125 evaluation unit
105, 117, 126 calculation unit
106, 118, 127 output unit
114 identification unit
115 presentation unit
123 parameter transmission unit
200, 210, 220 learning participant server
201, 211, 221 model generation unit
202, 212, 223 input/output unit
222 obfuscated unit
224 restoration unit
225 model storage unit
226 participant inference unit

What is claimed is:

1. An evaluation system comprising:
a memory configured to store instructions; and
one or more processors configured to execute the instructions to:
acquire, for a plurality of local models of learning participants for inferring a specific event, parameters of the plurality of local models;
integrate the acquired parameters of the plurality of local models;
execute the inference using an integrated model obtained by integrating the parameters of the plurality of local models;
evaluate a contribution of each of the local models based on a result of the inference; and
output the contribution.

2. The evaluation system according to claim 1, wherein
the one or more processors are further configured to execute the instructions to:
calculate a reward to a learning participant who has provided a parameter of a local model based on the contribution wherein; and
output the reward.

3. The evaluation system according to claim 1, wherein
the one or more processors are further configured to execute the instructions to:
acquire the parameters of the plurality of local models in an obfuscated format; and
integrate the parameters of the plurality of local models using secure computation.

4. An evaluation system comprising:
a memory configured to store instructions; and
one or more processors configured to execute the instructions to:
execute inference regarding a specific event based on an integrated model in which parameters of a plurality of local models are integrated by federated learning using secure computation;
evaluate a contribution of each of the local models based on a result of the inference; and
output the contribution.

5. The evaluation system according to claim 1, wherein
the one or more processors are further configured to execute the instructions to:
evaluate a contribution of each of the local models based on a change in inference accuracy of the integrated model due to integration of the parameters of the plurality of local models.

6. The evaluation system according to claim 1, wherein
the one or more processors are further configured to execute the instructions to:
evaluate a contribution of each of the local models based on a time at which a plurality of the learning participants participated in federated learning.

7. The evaluation system according to claim 5, wherein
the one or more processors are further configured to execute the instructions to:
add a contribution of the local model in a case where the plurality of learning participants participates in federated learning before inference accuracy of the integrated model reaches a predetermined threshold value.

8. The evaluation system according to claim 1, wherein
the one or more processors are further configured to execute the instructions to:
present information for recruiting a learning participant.

9. The evaluation system according to claim 8, wherein
the one or more processors are further configured to execute the instructions to:
present current inference accuracy of the integrated model and a threshold value of inference accuracy.

10. The evaluation system according to claim 8 wherein
the one or more processors are further configured to execute the instructions to:
identify a type of insufficient learning data based on at least any one of a type of learning data learned by the integrated model, a content of an event, and inference accuracy; and
present the identified type of the learning data.

11. The evaluation system according to claim 10, wherein
the one or more processors are further configured to execute the instructions to:
add a contribution of a local model generated based on the insufficient learning data.

12. An information processing system comprising:
a plurality of learning participant servers; and
the evaluation system according to claim 1, wherein
each of the learning participant servers includes:
a second memory configured to store second instructions; and
one or more second processors configured to execute the second instructions to:
store a learned model for executing inference regarding a specific event;
input, in an obfuscated format, a parameter updated by federated learning using secure computation for parameters of the stored model;
restore the input parameter; and
apply the restored parameter to the stored model to update the model; and
execute inference regarding the specific event.

13. An evaluation method executed by a computer, the method comprising:
acquiring, for a plurality of local models of learning participants for inferring a specific event, parameters of the plurality of local models;
integrating the acquired parameters of the plurality of local models;
executing the inference using an integrated model obtained by integrating the parameters of the plurality of local models;
evaluating a contribution of each of the local models based on a result of the inference; and
outputting the contribution.

14. (canceled)
